(19) United States
(12) Patent Application Publication
(10) Pub. No.: US 2025/0256612 A1
(43) Pub. Date: Aug. 14, 2025

(54) METHOD FOR DETERMINING A PREDICTIVE OPERATING SCENARIO OF A CHARGING STATION SYSTEM FOR ELECTRIC VEHICLES, ASSOCIATED CONTROL METHOD AND CHARGING STATION SYSTEM

(71) Applicant: Schneider Electric Industries SAS, Rueil Malmaison (FR)

(72) Inventors: Alban Puech, Casablanca (MA); Tristan Rigaut, Grenoble (FR)

(73) Assignee: Schneider Electric Industries SAS, Rueil Malmaison (FR)

(21) Appl. No.: 19/047,743

(22) Filed: Feb. 7, 2025

(30) Foreign Application Priority Data
Feb. 9, 2024 (FR) 2401270

(51) Int. Cl. B60L 53/67

(52) U.S. Cl. CPC B60L 53/67

(57) ABSTRACT

A method for determining a predictive operating scenario of a charging station system for electric vehicles including a power supply system and a plurality of charging stations powered by the power supply system and capable of charging electric vehicles. The method includes, for each charging station and for each time step of a time interval, maintaining the charging station in an active or inactive state, or changing the state of the charging station, with a probability of change of state calculated on the basis of: the time and date corresponding to the time step; a duration since the last change of state of the base station; and if the recharging station is in an active state, a time remaining before an announced end time for recharging the electric vehicle.

### TECHNICAL FIELD

The present invention relates to a method for determining a predictive operating scenario of a charging station system for electric vehicles, to a method for controlling a charging station system for electric vehicles using such a method for determining a predictive operating scenario, and to a charging station system for electric vehicles controlled by such a control method.

### BACKGROUND

A charging station system comprises an electrical energy supply system and several charging stations, each powered by the power supply system and each allowing electrical energy to be delivered to an electric vehicle.

Generally, when an electric vehicle is connected to a charging station, a request is sent by the vehicle or by the user of the vehicle to the charging station. This request includes the amount of electrical energy required by the vehicle for the charging thereof and an announced end of charging time, corresponding to a date and time when the vehicle user wishes to disconnect the vehicle from the charging station. The amount of electrical energy associated with the request is generally expressed in kWh, but also can be expressed in terms of distance, notably in kilometres, with this distance then being converted into kWh depending on the performance capabilities of the electric vehicle.

A common problem in managing such a charging station system is to limit the total electrical power delivered by the power supply system to the charging stations, so as not to exceed a maximum power threshold. This threshold corresponds, for example, to a physical limitation on the power that the power supply system is able to deliver, or even to a threshold stipulated by the electricity supplier of the charging station system I, or even to a threshold above which the price of electricity increases. However, complying with this maximum power threshold is challenging, in so far as the number of electric vehicles connected to the charging station system at a given instant and the amount of electrical energy requested by each vehicle are not known in advance.

In order to comply with this maximum power threshold, it is thus known for the electrical power delivered by some of the charging stations to the associated electric vehicles over certain time periods to be limited, in a reactive manner, as soon as the power delivered by the power supply system approaches the maximum power threshold. This approach entails the risk of failing to charge these vehicles with the requested amount of electrical energy before the announced end of charging time, creating dissatisfaction among users of these vehicles.

It is also known for a predictive operating scenario of the charging station system to be established, so as to anticipate periods when the power delivered by the power supply system is likely to approach the maximum power threshold and so as to smoothen the charging of the electric vehicles over time, for example, by delaying the charging of some vehicles. Such a scenario is generally solely based on the operating log of the charging station system. The disadvantage of such an approach is that it is unreliable, as the predictive operating scenario often proves to be inaccurate, resulting in the maximum power threshold being exceeded, for example, if a larger number of electric vehicles than expected simultaneously connect to the charging station system, and resulting in dissatisfaction among the users of the vehicles. In particular, delaying the charging of some vehicles can result in the amount of electrical energy requested by the vehicle for the charging thereof not being met, i.e., in a lower amount of energy being supplied than has been requested by the user, which notably occurs when the vehicle user disconnects the vehicle from the charging station before the announced end of charging time.

### SUMMARY

Therefore, an aim of the invention is to propose a method for determining a predictive operating scenario of a charging station system for electric vehicles, allowing a predictive scenario to be obtained that is more likely to be achieved than the scenarios established according to known approaches, i.e., a predictive scenario that is more realistic than the scenarios that are established according to known approaches.

To this end, the aim of the invention is a method for determining a predictive operating scenario of a charging station system for electric vehicles over a predetermined time interval comprising a plurality of time steps, the charging station system comprising:
a power supply system; and
a plurality of charging stations, each charging station being configured to be supplied with electrical energy by the power supply system and to deliver electrical energy to an electric vehicle, each charging station being either in an inactive state, when it is incapable of charging an electric vehicle, or in an active state, when it is capable of charging an electric vehicle.
   The method comprising, for each charging station and for each time step of the predetermined time interval, maintaining the charging station in its state or changing the state of the charging station, with a probability of changing the state of the charging station being computed based on:
the time and date corresponding to the active time step;
a session duration, expressed as a number of time steps, separating the active time step from the last past time step during which the charging station changed state; and
if the charging station is in the active state, a remaining duration, expressed as a number of time steps, separating the active time step from a future time step corresponding to a time and a date for the end of charging of the electric vehicle, the time and the date for the end of charging of the electric vehicle being determined during a past time step during which the charging station switched to the active state;
   the method further comprising a step of determining a digital representation of a predictive operating scenario of the charging station system comprising, for each time step, the state of each charging station.

By virtue of the invention, the predictive scenario determined by the method incorporates the risk of an electric vehicle being disconnected early by its user before the announced end of charging time, by taking into account the duration remaining between each time step and the announced end of charging time and date. This predictive scenario then can be used to control a charging station system, and this consideration of the risk of early disconnection then allows an acceptable charging level to be obtained for the charged electric vehicles, even when they are disconnected early. The predictive scenario is thus more reliable and robust, and the satisfaction of the users of the charged vehicles is increased.

According to other advantageous aspects of the invention, the determination method comprises one or more of the following features, taken alone or according to any technically feasible combination:
The method comprises, for each charging station and for each time step of the predetermined time interval, the following steps:
a) determining the state of the charging station;
b) if the charging station is in the inactive state at the start of the time step, then:
   maintaining the charging station in the inactive state; or.
   switching the charging station to the active state and computing an initial charging request, expressed as an amount of electrical energy, with a probability of switching the charging station to the active state that is equal to a first value, the first value is computed based on:
      the time and date corresponding to the active time step; and
      a session duration, expressed as a number of time steps, separating the active time step from the past time step during which the charging station switched to the inactive state;
c) if the charging station is in the active state at the start of the time step, then:
   maintaining the charging station in the active state; or.
   switching the charging station to the inactive state, with a probability of switching the charging station to the inactive state that is equal to a second value, the second value is computed based on:
      the time and date corresponding to the active time step;
      a session duration, expressed as a number of time steps, separating the active time step from the past time step during which the charging station switched to the active state; and
      a remaining duration, expressed as a number of time steps, separating the active time step from a future time step corresponding to a time and a date for the end of charging of the electric vehicle, the time and the date for the end of charging of the electric vehicle being determined during a past time step during which the charging station switched to the active state;
         the digital representation of the predictive scenario further comprising, for each time step and when a charging station is in the active state, the initial charging request associated with the charging station.
During step c):
   if the charging station has been in the active state since the start of the initial time step of the predetermined time interval, then the probability of switching the charging station to the inactive state is equal to the second value; and
   if the charging station has not been in the active state since the start of the initial time step of the predetermined time interval, then the probability of switching the charging station to the inactive state is equal to a third value, the third value being computed based on:
      the time and date corresponding to the active time step; and
      a session duration, expressed as a number of time steps, separating the active time step from the past time step during which the charging station switched to the active state.
Step c) further comprises, after switching the charging station to the inactive state:
   switching the charging station to the active state and computing an initial charging request, expressed as an amount of electrical energy, with a probability of switching the charging station to the active state that is equal to the first value.
Determining the state of the charging station during step a) comprises:
   for the first time step of the predetermined time interval, obtaining the state of the charging station from data supplied prior to the implementation of the method; and
   for each time step of the predetermined time interval different from the first time step, obtaining the state of the charging station at the end of the preceding time step.
During step b), computing the initial charging request is carried out based on:
   the time and date corresponding to the active time step; and
   a session duration, expressed as a number of time steps, separating the active time step from the past time step during which the charging station switched to the inactive state.
Step c) comprises:
   checking whether the remaining duration separating the active time step from the future time step corresponding to an announced time and date for the end of charging of the electric vehicle is equal to zero time steps;
   if the remaining duration is equal to zero time steps, switching the charging station to the inactive state; and
   if the remaining duration is greater than zero time steps, maintaining the charging station in the active state or switching the charging station to the inactive state, with a probability of switching the charging station to the inactive state that is equal to the second value.
The first value, the second value and, if applicable, the third value, are respectively obtained using a gradient-boosting classifier machine learning algorithm.

A further aim of the invention is to propose a method for controlling a charging station system that allows, by using multiple predictive operating scenarios, a more efficient charging setpoint to be obtained for each charging station of the charging station system, in order to improve the satisfaction of the users of charged vehicles by better complying with the request made by the vehicles. Thus, according to another aspect, the invention also relates to a method for controlling a charging station system for electric vehicles, the charging station system comprising:
a power supply system;
a plurality of charging stations, each charging station of the plurality of charging stations being supplied with electrical energy by the power supply system and being configured to deliver electrical energy to an electric vehicle, each charging station being either in an inactive state, when it is incapable of charging an electric vehicle, or in an active state, when it is capable of charging an electric vehicle; and
a computation device, configured to control the amount of electrical energy delivered to each charging station by the power supply system;
   the method being implemented by the computation device and comprising the following steps:
a) determining the time and date of the current instant;
b) determining, for each charging station of the plurality of charging stations, whether the charging station is in the inactive state or in an active state at the current instant, and determining an initial charging request associated with each charging station in the active state;
c) generating a plurality of predictive operating scenarios for the charging station system by repeatedly implementing the method for determining a predictive scenario as described above;
d) establishing an operating setpoint of the charging station system, based on:
   the state of each charging station determined in step b);
   the initial charging request associated with each charging station in the active state determined in step b); and
   the plurality of predictive operating scenarios for the charging station system generated in step c);
      with the established operating setpoint of the charging station system allocating an amount of electrical energy to be delivered by the power supply system to each charging station; and
e) controlling, by the computation device, the power supply system to deliver the amount of electrical energy allocated to each charging station by the operating setpoint.

By virtue of the control method according to the invention, the operating setpoint of the charging station system is based on a multitude of predictive operating scenarios incorporating the possibility that users will stop charging their vehicle before the announced end of charging time. The operating setpoint then anticipates such early disconnections and is therefore more efficient, which improves the satisfaction of the users of the charged vehicles.

According to other advantageous aspects of the invention, the control method comprises one or more of the following features, taken alone or according to any technically feasible combination:
During step d), the operating setpoint of the charging station system is established using a two-stage stochastic programming model, in which the operating setpoint of the charging station system represents a decision variable and in which the plurality of predictive operating scenarios for the charging station system, generated by repeatedly implementing the method for determining a predictive scenario during step c), represents a probability distribution.
The two-stage stochastic programming model attempts to:
   maintain a total amount of electrical energy delivered by the power supply system to the plurality of charging stations below a predetermined maximum energy threshold; and
   maximise a charging percentage of each electric vehicle charged by a charging station in the active state, the charging percentage xₜⁱ of each electric vehicle being obtained using the following equation:

$${x}^{i} = 1 - \frac{{r}^{i}}{{k}^{i}}$$

where kⁱ corresponds to the initial charging request associated with the charging station and rⁱ corresponds to the remaining amount of electrical energy to be delivered to the electric vehicle associated with the charging station in order to fulfil the initial charging request.
During step d), the operating setpoint of the charging station system is also established based on the deviation between an operating setpoint determined by a previous execution of the control method and the amount of electrical energy actually delivered to each charging station since said previous execution of the control method.
Steps a) to e) are implemented periodically, being repeated after a duration that is equal to the duration of a time step of the predetermined time interval.
The two-stage stochastic programming model also attempts to minimise a cost of the electrical energy delivered by the power supply system to the plurality of charging stations.

According to another aspect, the invention also relates to a charging station system for electric vehicles comprising:
a power supply system;
a plurality of charging stations, each charging station of the plurality of charging stations being supplied with electrical energy by the power supply system and being configured to deliver electrical energy to an electric vehicle; and
a computation device, configured to control the amount of electrical energy delivered to each charging station by the power supply system;
   wherein the computation device is configured to implement the control method described above.

### BRIEF DESCRIPTION OF THE DRAWINGS

The invention will become more clearly apparent upon reading the following description, which is provided solely by way of a non-limiting example and with reference to the drawings, in which:

FIG. 1 is a schematic representation of a charging station system for electric vehicles according to the invention.

FIG. 2 is a flowchart illustrating a method for controlling a charging station system for electric vehicles according to the invention.

FIG. 3 is a flowchart illustrating a method for determining a predictive operating scenario of a charging station system for electric vehicles according to the invention.

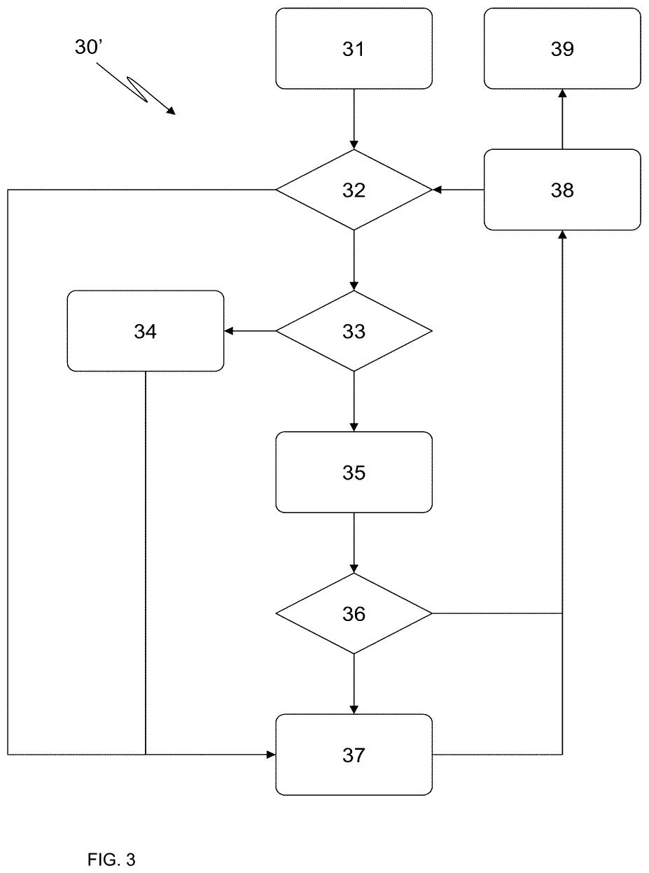

### DETAILED DESCRIPTION

Within the scope of the present invention, the word “instant” describes the smallest component of time and the expression “time interval” designates a duration between two instants. In addition, a time interval is subdivided into several time steps. Thus, the expression “time step” designates a duration between two instants, which belongs to a time interval, with the duration of a time step being shorter than the duration of a time interval. In other words, several consecutive time steps define a time interval.

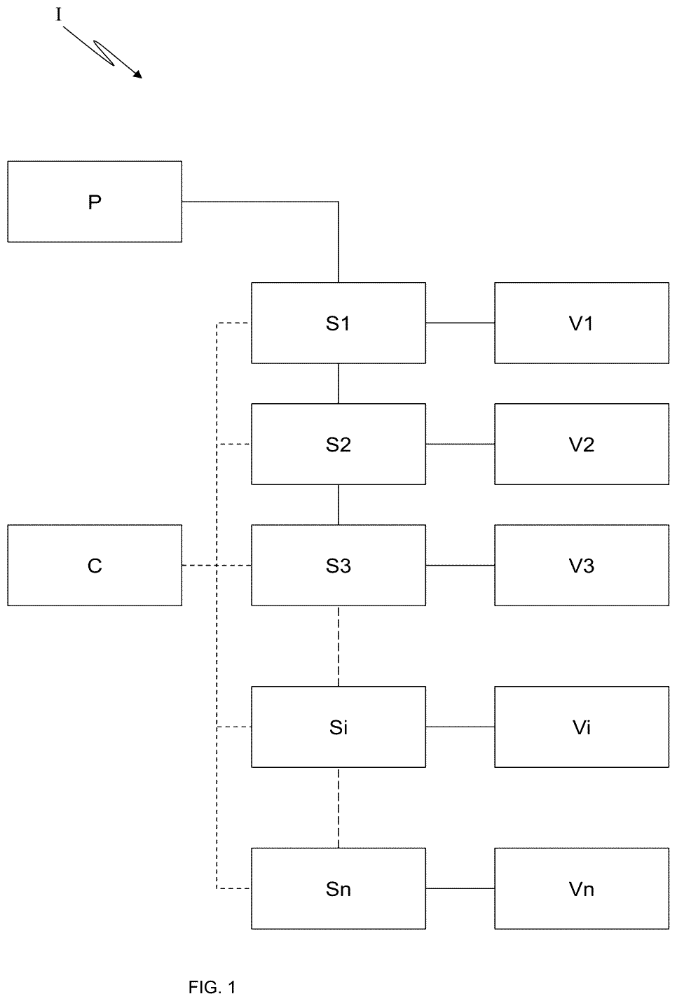

A charging station system I for electric vehicles is schematically shown in FIG. 1. The charging station system I comprises a power supply system P, a computation device C and a plurality of charging stations.

In practice, the charging station system I comprises a whole number n of charging stations; therefore, the plurality of charging stations is designated using reference S1-Sn. Five charging stations are shown in FIG. 1, namely, S1, S2, S3, Si and Sn, respectively. Throughout the remainder of the description, each charging station of the plurality of charging stations S1-Sn is designated using reference Si. The charging stations Si are also designated using the abbreviation EVCS (Electric Vehicle Charging Station).

The charging station system I comprises a number of charging stations Si equal to N, with N generally ranging between 1 and 1000, for example, ranging between 15 and 50. In practice, the invention can also apply to charging station systems I comprising more than 1000 charging stations Si.

Each charging station allows an associated electric vehicle to be charged, i.e., an electric vehicle connected to the charging station. Thus, the charging station system I can simultaneously charge a plurality of electric vehicles designated using reference V1-Vn. Five electric vehicles are shown in FIG. 1, namely, V1, V2, V3, Vi and Vn, respectively associated with, or connected to, the charging stations S1, S2, S3, Si and Sn, respectively. Throughout the remainder of the description, each electric vehicle of the plurality of electric vehicles V1-Vn is designated using reference Vi. Each electric vehicle Vi comprises a battery, or a set of batteries, for storing the electrical energy supplied by the charging station and for powering the electric vehicle with electrical energy.

The power supply system P supplies each of the charging stations Si with electrical energy in order to allow the electric vehicles Vi to be charged. To this end, the power supply system P is connected to an electrical network, not shown, for example, a three-phase alternating current electrical network. In other words, the charging stations Si distribute the electrical energy delivered by the power supply system P to the electric vehicles Vi.

Thus, each charging station Si is either active, i.e., in a first state, called active state, or inactive, i.e., in a second state, called inactive state.

A charging station Si is in an active state when it is charging an electric vehicle Vi associated therewith, i.e., when it is able, or capable, of delivering electrical energy to this electric vehicle. In other words, a charging station is in an active state even when it does not deliver electrical energy to an electric vehicle, but is likely to do so: for example, if an electric vehicle is charged in two phases separated by a pause, during which the vehicle remains connected to the charging station but during which the charging station does not deliver electrical energy to the vehicle, then the charging station is considered to be in an active state during this pause. In other words, the power supply system P is capable of distributing electrical power to a charging station in an active state. When a charging station Si is in an active state, the electrical power delivered by the power supply system P to the charging station ranges between 0 KW, inclusive, and a maximum electrical power acceptable to the charging station. By way of example, each of the charging stations Si is generally dimensioned to be able to receive a maximum electrical power from the power supply system P that ranges between 3.7 KW and 7.4 KW, for example, that is equal to 6 kW. Thus, a charging station in the active state requests electrical energy from the power supply system P, or expects electrical energy from the power supply system, which may or may not deliver electrical energy to the charging station as a function of the operating setpoint obtained using the control method described hereafter.

A charging station Si is in an inactive state when it is not charging any electric vehicle Vi, i.e., when it cannot deliver electrical energy to a vehicle. For example, a charging station Si is in an inactive state when no electric vehicle Vi is connected to the charging station, or even when an electric vehicle Vi is connected to the charging station, but charging of said electric vehicle has been completed. In other words, the power supply system P is not likely to distribute electrical power to a charging station in an inactive state. When a charging station Si is in an inactive state, the electrical power delivered by the power supply system P to the charging station is equal to 0 kW. Thus, a charging station in an inactive state does not request any electrical energy from the power supply system P.

A charging station Si switches from its inactive state to its active state when an electric vehicle Vi is connected to the charging station and a charging session for the electric vehicle thus begins.

In practice, when an electric vehicle Vi is connected to a charging station Si, the electric vehicle Vi sends two items of information to the charging station Si:
an initial charging request, corresponding to the amount of electrical energy, expressed in kWh, required to charge the electric vehicle; and
optionally, an end of charging time, corresponding to an announced end of charging time and date, at which the electric vehicle charging session must end.

As the end of charging time is optional, an electric vehicle Vi may only send an initial charging request when it is connected to a charging station Si.

The initial charging request and/or the end of charging time are preferably selected by a user of the electric vehicle Vi or are even automatically determined by an on-board computer of the electric vehicle.

Generally, the initial charging request associated with an electric vehicle Vi corresponds to the amount of electrical energy that can be received by the battery of the electric vehicle in order to reach a battery charge level that is equal to 100%. However, the initial charging request associated with an electric vehicle Vi can correspond to an amount of electrical energy that allows the battery of the electric vehicle to be only partially charged, for example, to a charging level that is equal to 80%. In this case, the charging session of the electric vehicle ends as soon as the battery of the electric vehicle is charged by an amount of electrical energy that is equal to the initial charging request, even when the battery is not fully charged.

The computation device C is configured to control the electrical power delivered to each charging station Si by the power supply system P. In other words, the computation device C controls the distribution of the electrical energy delivered by the power supply system P to the charging stations Si.

The computation device C is physically connected to the power supply system P or is even remotely connected to the power supply system P. For example, the computation device C can be a remote server.

The computation device C is designed to implement a control method 10 corresponding to a method for controlling the charging station system I that will be described hereafter.

The computation device C is also designed to implement a determination method 30′ corresponding to a method for determining a predictive operating scenario of the charging station system I, which will be described hereafter.

The computation device C is an electronic circuit designed to handle and/or convert data represented by electronic or physical quantities in registers of the computer and/or memories into other similar data corresponding to physical data in the memories of registers or other types of display devices, transmission devices or storage devices.

As specific examples, the computation device C is at least partially produced in the form of a programmable logic component, such as an FPGA (Field Programmable Gate Array), or even an integrated circuit, such as an ASIC (Application Specific Integrated Circuit).

As a variant, when the control method 10 and/or the determination method 30′ are implemented by one or more software programs, i.e., in the form of a computer program, also called computer program product, they are also able to be stored on a computer-readable medium, not shown. The computer-readable medium is, for example, a medium capable of storing electronic instructions and of being coupled to a bus of a computer system. For example, the readable medium is an optical disk, a magneto-optical disk, a ROM memory, a RAM memory, any type of non-volatile memory (for example, FLASH or NVRAM) or a magnetic card. A computer program containing software instructions is then stored on the readable medium. This computer program thus can be implemented by one or more computers comprising one or more processors.

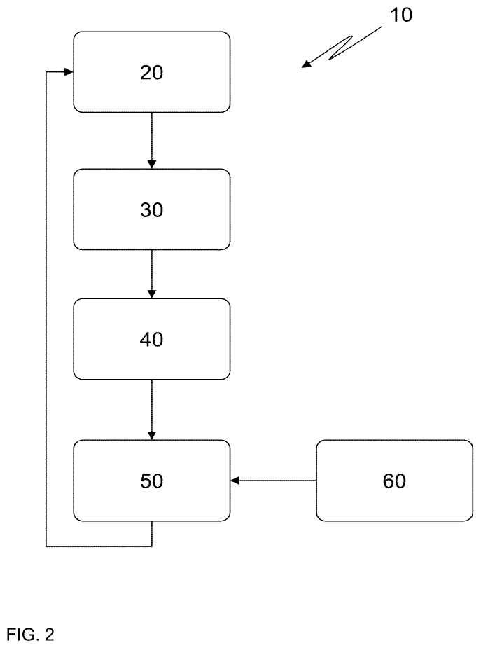

The method for controlling the charging station system I, referred to throughout the remainder of the description as “control method 10”, will now be described with reference to FIG. 2.

The aim of the control method 10 is to determine the electrical power delivered by the power supply system P to each charging station Si in the active state in order to optimise the charging of the associated electric vehicles, while minimising the operating costs of the charging station system I. To this end, the control method 10 relies on generating a number of predictive operating scenarios simulating the operation of the charging station system I over a given time interval, while incorporating into these simulations the risk that users will stop charging their vehicle before the announced end of charging time. Thus, the control method 10 allows decision making in an uncertain context. These predictive operating scenarios are generated using a determination method described hereafter.

The control method 10 is implemented periodically in order to determine the amount of electrical energy that must be delivered by the power supply system P to each charging station Si in the active state. In the example, the repetition period of the control method 10, i.e., its periodicity, corresponds to one time step. In other words, the duration of a time step corresponds to the duration between two executions of the control method 10.

A cycle of the control method 10 will now be described, i.e., a complete execution of the control method 10 at a given instant.

The control method 10 comprises a step 20 in which the time and date of the current instant are determined. Preferably, the time and date of the current instant are determined by the computation device C, for example, using a real-time clock, or RTC module, integrated into the computation device C, or are even obtained by the computation device C from external information, for example, from information obtained from the Internet. This determination notably allows the day of the week to be determined that corresponds to the current instant and is thus used to know whether the current instant corresponds to a working day, a public holiday, a weekend, etc.

During step 20, the control method 10 also involves, for each charging station Si, determining whether the charging station is in an active state or in an inactive state at the current instant, as well as determining the initial charging request associated with each charging station Si in an active state.

The control method 10 then comprises a step 30 during which the computation device C generates a plurality of predictive operating scenarios of the charging station system I, for each time step of a predetermined time interval, with an initial time step of the predetermined time interval including the current instant, i.e., the current instant during which step 20 is implemented. Preferably, the initial time step starts at the current instant.

The predetermined time interval thus corresponds to a simulation duration, i.e., a duration during which the predictive operating scenarios of the charging station system are generated. In other words, each time the control method 10 is implemented, the operation of the charging station system is simulated for a duration that is equal to the predetermined time interval and that starts at the instant when the control method is implemented. The start of this simulation thus corresponds to the current instant, i.e., the instant for implementing the control method. The end of this simulation thus corresponds to the final instant of the predetermined time interval, i.e., to the final instant of the last time step of the predetermined time interval.

In practice, the predetermined time interval comprises a plurality of time steps of equal duration. The duration of each time step is 15 minutes, for example. The predetermined time interval comprises 96 time steps, for example, thus corresponding to a total duration of 24 hours, in the example.

A long predetermined time interval improves the consideration of possible future variations in the operation of the charging station system I, and therefore improves the accuracy of each predictive operating scenario. A short predetermined time interval reduces the computation time required to implement the control method 10. Thus, a predetermined time interval of 24 hours corresponds to a satisfactory compromise between these two constraints. As a variant, the predetermined time interval has a total duration other than 24 hours, for example, 48 hours.

A long time step results in the establishment of imprecise predictive operating scenarios, whereas a short time step results in an increase in the computation time required to establish the predictive operating scenarios. Thus, a time step that is equal to 15 minutes is a satisfactory compromise between these two constraints.

In practice, the duration of the time step and the duration of the predetermined time interval also can be selected as a function of external constraints, for example, as a function of the frequency at which the charging station system I is notified of the price of electricity.

Each predictive operating scenario of the charging station system I is generated by implementing a method for determining a predictive operating scenario of the charging station system I, which will be described hereafter and which is referred to throughout the remainder of the description as the “determination method 30”. In other words, during step 30, the determination method 30′ is implemented several times, preferably between 2 and 10 000 times, for example, 200 times.

Each predictive operating scenario of the charging station system I associates, for each time step of a predetermined time interval, the state (active or inactive) of each charging station Si and, preferably, the initial charging request associated with each charging station Si in the active state.

This plurality of predictive operating scenarios is used in the control method 10 in order to obtain an optimal operating setpoint, as described hereafter. Thus, each predictive operating scenario is not directly used to control the operation of the charging station system I. Each predictive operating scenario also can be described as a probable operating scenario, a possible operating scenario or a future operating scenario.

The control method 10 then comprises a step 40 during which the computation device C establishes an operating setpoint of the charging station system during the time step of the predetermined time interval immediately following the initial time step, with this operating setpoint being established based on:
the state of each charging station Si determined in step 20, corresponding to the state (active or inactive) of each charging station Si during the initial time step of the predetermined time interval;
the initial charging request associated with each charging station Si in the active state determined in step 20; and
the plurality of predictive operating scenarios of the charging station system I generated in step 30.

Throughout the remainder of the description, the time step of the predetermined time interval immediately following the initial time step is referred to as the “controlled time step”.

The operating setpoint of the charging station system I is thus established during the initial time step, and allocates an amount of electrical energy to be delivered by the power supply system P to each charging station Si during the controlled time step. In other words, the operating setpoint is applied during the controlled time step.

In other words, the operating setpoint of the charging station system I corresponds to a decision, or a command, stipulating the operation of the charging station system during the controlled time step. This operating setpoint allows the electrical power from the power supply device P to be distributed as effectively as possible to the charging stations Si during the controlled time step.

The control method 10 then comprises a step 50 during which the computation device C controls the power supply device P so that the power supply device P delivers the amount of electrical power allocated to each charging station Si by the operating setpoint during the controlled time step. Thus, step 50 is implemented during the controlled time step, and not during the initial time step.

In other words, during step 50, each charging station Si receives an amount of electrical energy that is determined by the operating setpoint for recharging the electric vehicle Vi associated with the charging station SI. It is thus understood that the charging stations Si in the inactive state receive a zero amount of electrical energy, since they are unable to charge an electric vehicle, i.e., the power supply device P allocates zero electrical power to them. On the contrary, the charging stations Si in the active state each receive an amount of electrical energy ranging between 0 kWh and a maximum amount of electrical energy corresponding to the amount of electrical energy received by the charging station for the duration of a time step when the power supply system P delivers maximum electrical power to the charging station, i.e., the power supply device P allocates non-zero electrical power to them.

To summarise, by virtue of the control method 10, during the initial time step, the computation device C determines the state of each charging station Si and generates a plurality of predictive operating scenarios of the charging station system I, then establishes an operating setpoint of the charging station system I based on the generated predictive operating scenarios, with this operating setpoint being implemented during the controlled time step.

Step 50 thus corresponds to the operation of the charging station system I during the controlled time step. In practice, during this time step, the actual operation of the charging station system I does not generally fully correspond to the operating setpoint established during step 40, since external actions 60 different from those predicted by the operating setpoint can occur. For example, a user of an electric vehicle Vi can disconnect their electric vehicle from the associated charging station Si before the announced end of charging time without any provision of this early disconnection during step 40, such that the associated charging station Si cannot deliver the entire amount of electrical energy determined by the operating setpoint to the electric vehicle Vi during the controlled time step.

Thus, during step 50, i.e., during the controlled time step, the amount of electrical energy distributed by each charging station Si in the active state is equal to or less than the amount of electrical energy determined by the operating setpoint.

Furthermore, during the controlled time step, another external action 60 that can occur corresponds to the connection of a new electric vehicle Vi to a charging station Si, in order to start a charging session for this electric vehicle. In other words, such an external action causes the charging station Si to switch from its inactive state to its active state. If such a connection of an electric vehicle to the charging station Si has been incorporated into the operating setpoint of the charging station system, i.e., if the operating setpoint anticipated the charging station switching to the active state and the charging station being supplied with a non-zero amount of electrical energy, then charging of the electric vehicle Vi starts from the controlled time step. Otherwise, charging of the electric vehicle does not start during the controlled time step.

As a variant, the operating setpoint established in step 40 of the control method 10 further comprises an additional rule, or expert rule, that stipulates that, when an electric vehicle is connected to a charging station Si without this connection having been incorporated in the operating setpoint, then the charging station immediately starts charging the electric vehicle, for example, at the maximum electrical power that can be delivered by the charging station. This variant avoids any delay in starting to charge an electric vehicle that connects unexpectedly, thus improving user satisfaction.

The control method 10 is implemented periodically, i.e., steps 20, 30, 40 and 50 are implemented cyclically, being repeated after a duration that is equal to the duration of the time steps of the predetermined time interval.

It should be noted that, in the example, steps 20, 30 and 40 of the control method 10 are executed during the initial time step, whereas step 50 is executed during the controlled time step.

Preferably, steps 20, 30 and 40 of the control method 10 are implemented at the end of the initial time step, for example, at the instant separating the initial time step from the controlled time step. In this way, the operating setpoint is also established based on the possible change of state of charging stations Si from their active state to their inactive state occurring during the initial time step, and based on the possible change of state of charging stations from their inactive state to their active state occurring during the initial time step and the initial charging request associated with these charging stations switching to the active state. Thus, the operating setpoint used during the controlled time step takes into account the changes occurring in the charging station system I during the initial time step. In other words, the external actions 60 occurring during the initial time step of a cycle of the control method 10 are taken into account in order to establish the operating setpoint that is implemented during the controlled time step of this cycle of the control method.

In practice, the duration for executing steps 20, 30 and 40 is much less than the duration of a time step of the predetermined time interval, for example, of the order of a few seconds, or of a few hundred milliseconds.

More preferably, the operating setpoint established during step 40 is also established based on the actual operating log of the charging station system I.

More preferably, the operating setpoint established during step 40 is also established based on the deviations that have occurred during the time steps preceding the initial time step between the operating setpoints established by the control method 10 and the actual operation of the charging station system, i.e., the operating setpoint is also established by taking into account past errors of the control method 10. In practice, these deviations, or errors, are caused by the external actions 60 occurring during the controlled time step. In other words, for each past time step belonging to a past time interval prior to the current instant, the operating setpoint established during step 40 of the control method 10, implemented during the initial time step, is also established based on the deviation between the operating setpoint of the charging station system I established during step 40, implemented during said past time step, and the operation of the charging station system I during the time step immediately following said past time step. Thus, the operating setpoint of a cycle of the control method is adjusted in order to take into account any deviations between the operating setpoints of the previous cycles and the actual operation of the system, such that the control method 10 acts as a closed-loop control system. In other words, the operating setpoint of the charging station system is established by taking into account the deviation between an operating setpoint determined by a previous execution of the control method 10 and the amount of electrical energy actually delivered to each charging station since said previous execution of the control method.

The way the operating setpoint of the charging station system I is established during step 40 of the control method 10 will now be described in further detail. Preferably, this operating setpoint is established using a two-stage stochastic programming model, in which the operating setpoint of the charging station system I represents a decision variable and in which the plurality of predictive operating scenarios of the charging station system I generated by the determination method 30′ during step 30 represents a probability distribution.

A two-stage stochastic programming model is also referred to as two-stage stochastic programming.

Advantageously, this two-stage stochastic programming model attempts to achieve three objectives:
to maintain a total amount of electrical energy delivered by the power supply system P to the plurality of charging stations S1-Sn, during each time step of the predetermined time interval, below a predetermined maximum energy threshold;
to maximise a charging percentage of each electric vehicle Vi charged by a charging station Si in an active state at the instant of its scheduled disconnection, i.e., to maximise the predictive charging percentage of each electric vehicle Vi at the end of its charging session, so as to maximise the satisfaction of the users of the electric vehicles Vi charged by the charging station system I; and
preferably, to minimise a cost of the electrical energy delivered by the power supply system P to the plurality of charging stations S1-Sn during the predetermined time interval.

The total amount of electrical energy delivered by the power supply system P to the plurality of charging stations S1-Sn during the controlled time step, denoted c, is obtained using the following equation:

$$c = \sum {e}_{t}^{i}$$

where eₜⁱ corresponds to the amount of electrical energy delivered by the power supply system P to each charging station Si during the controlled time step.

In practice, this equation also allows the total amount of electrical energy to be obtained that is delivered by the power supply system P to the plurality of charging stations S1-Sn during each time step of the predetermined time interval.

Thus, maintaining the total amount of electrical energy delivered by the power supply system P to the plurality of charging stations S1-Sn during the controlled time step below the predetermined maximum energy threshold, denoted c̅1̅, amounts to complying with the following inequality:

c≤c̅1̅

Compliance with this inequality is stringent, in so far as the predetermined maximum energy threshold c̅1̅ cannot be exceeded.

This threshold corresponds, for example, to a physical limitation of the power that the power supply system P is capable of delivering, or even to a threshold stipulated by the electricity supplier of the charging station system I.

The charging percentage of each electric vehicle Vi charged by a charging station Si in the active state at the end of the controlled time step, denoted xⁱ, is obtained using the following equation:

$${x}^{i} = 1 - \frac{{r}^{i}}{{k}^{i}}$$

where:
kⁱ corresponds to the initial charging request associated with the charging station Si;
rⁱ corresponds to the remaining amount of electrical energy to be delivered to the electric vehicle Vi associated with the charging station Si in order to fulfil the initial charging request at the end of the controlled time step. This value is notably obtained based on the amount of electrical energy delivered by the charging station Si to the electric vehicle since the start of the charging session, and also takes into account the efficiency of the charging of the electric vehicle, i.e., any losses between the amount of electrical energy delivered by the charging station and the amount of additional electrical energy actually stored by the battery of the electric vehicle.

In practice, this equation also allows the charging percentage to be obtained for each electric vehicle Vi charged by a charging station Si in the active state at the end of each time step of the predetermined time interval.

The cost of the electrical energy delivered by the power supply system P to the plurality of charging stations S1-Sn during the controlled time step, denoted C and expressed as a monetary amount, for example, in euro, is preferably obtained using the following equation:

$$C = c \times p + {1}_{> \overline{c 1}} ( {c}_{t} ) \times ξ$$

where:
c corresponds to the total amount of electrical energy delivered by the power supply system P to the plurality of charging stations S1-Sn during the controlled time step;
p corresponds to the price of electricity during the controlled time step, expressed as a monetary quantity per amount of electrical energy, with this price of electricity being able to vary from one time step to another;
1_{>c̅}(cₜ) is an indicator, equal to 0 when c≤c̅2̅ and equal to 1 when c>c̅2̅, with c̅2̅corresponding to a predetermined tariff increase threshold, expressed as an amount of electrical energy and being less than the predetermined maximum energy threshold c̅1̅; and
ξ corresponds to a penalty, expressed as a monetary amount, to be paid if the total amount of electrical energy delivered by the power supply system P exceeds the predetermined tariff increase threshold.

In practice, this equation also allows the cost of the electrical energy to be obtained that is delivered by the power supply system P to the plurality of charging stations S1-Sn during each time step of the predetermined time interval.

As a variant, the cost C is computed without taking into account the predetermined tariff increase threshold, i.e., no penalty is paid if the total amount of electrical energy delivered by the power supply system P exceeds the predetermined tariff increase threshold.

In order to quantify the fulfilment of the two objectives of maximising the charging percentage of each electric vehicle Vi and minimising the cost of the electrical energy delivered by the power supply system P, during the controlled time step, but also during each time step of the predetermined time interval, a total cost variable is defined, denoted L and expressed as an amount of a monetary unit. This total cost is obtained using the following equation:

$$L = C + {w}_{s} \times ( 1 - {x}^{i} )$$

where wₛ is a coefficient, expressed as an amount of a monetary unit, expressing the weight given to user satisfaction. In other words, the coefficient wₛ assigns a monetary value to user dissatisfaction, which allows these two objectives to be quantified using a single variable.

Advantageously, by modifying the value of the coefficient wₛ, the importance given to user satisfaction is weighted in relation to the cost of electrical energy, which allows greater significance to be granted to the second objective or the third objective. In practice, the value of the coefficient wₛ is selected as a function of the specific features of each charging station system I and the preferences of the managers of these systems.

Thus, the two-stage stochastic programming model attempts to minimise the total cost L, while maintaining the total amount of electrical energy c delivered by the power supply system P to the plurality of charging stations S1-Sn during the controlled time step below the predetermined maximum energy threshold c̅1̅.

In practice, in order to achieve these three objectives, the two-stage stochastic programming model uses a collection K of samples drawn from a probability distribution. Each sample k of the collection K corresponds to a predictive operating scenario of the charging station system I obtained by virtue of the determination method 30′ described hereafter and associating, for each time step of a predetermined time interval, the state (active or inactive) of each charging station Si and the initial charging request associated with each charging station Si in the active state. The two-stage stochastic programming model is then expressed according to the following equation:

$$arg {min}_{{u}_{{t}_{0}} ∈ U} {min}_{{{u}_{t}^{k} , ∀ k ∈ \{ 1 , ... , K \} ,}_{∀ t ∈ \{ {t}_{0} , ... , {t}_{0} + R \}}} {\sum }_{{k ∈ \{ 1 , ... , K \} ,}_{t ∈ \{ {t}_{0} , ... , {t}_{0} + R \}}} {L}_{t} ( {x}_{t}^{k} , {u}_{t}^{k} , {\hat{w}}_{t}^{k} )$$

$$s . t . {x}_{t + 1}^{k} = {f}_{t} ( {x}_{t}^{k} , {u}_{t}^{k} , {\hat{w}}_{t}^{k} ) , ∀ k ∈ \{ 1 , ... , K \} , ∀ t , {t}_{0} \leq t \leq {t}_{0} + R$$

$${g}_{t} ( {x}_{t}^{k} , {u}_{t}^{k} , {\hat{w}}_{t}^{k} ) \leq 0 , ∀ k ∈ \{ 1 , ... , K \} , ∀ t , {t}_{0} \leq t \leq {t}_{0} + R$$

$${x}_{{t}_{0}}^{k} = {x}_{{t}_{0}} , {u}_{{t}_{0}}^{k} = {u}_{{t}_{0}} , ∀ k ∈ \{ 1 , ... , K \}$$

where:
t₀ and t_{0+R} respectively correspond to the initial time step of the predetermined time interval and to the last time step of the predetermined time interval, with the index t representing a time step in this predetermined time interval;
Lₜ(xₜ^{k}, uₜ^{k}, ŵₜ^{k}) corresponds to the cost L computed for the time step t,
xₜ^{k} is a first state variable representing, for each sample k of the collection K and for each time step t, the state (active or inactive) of each charging station Si, the initial charging request kⁱ associated with each charging station Si in the active state and the remaining amount of electrical energy rⁱ to be delivered to the electric vehicle Vi associated with each charging station Si in the active state;
uₜ^{k} is a second state variable representing, for each sample k of the collection K and for each time step t, the electrical energy delivered by the power supply system P to each charging station Si;
ŵₜ^{k} is an exogenous uncertainty variable representing, for each sample k of the collection K and for each time step t, a probability of changing the state of each charging station Si between its active and inactive states, and, for each change of state of a charging station Si from the inactive state to the active state, an initial charging request kⁱ and an associated announced end of charging time, with the announced end of charging time being expressed as a number of time steps;
fₜ(xₜ^{k}, uₜ^{k}, ŵₜ^{k}) represents a dynamic function allowing, for each time step t+1, the first state variable xₜ₊ₜ^{k} to be obtained from the first state variable xₜ^{k}, the second state variable uₜ^{k} and the exogenous uncertainty variable ŵₜ^{k} of the time step t;
gₜ(xₜ^{k}, uₜ^{k}, ŵₜ^{k})≤0 represents the constraints that must be followed by the two-stage stochastic programming model.

The resolution of the equation expressing the two-step stochastic programming model then allows the operating setpoint of the charging station system I to be obtained that is used to control the amount of electrical energy delivered by the power supply system P to each charging station Si during the controlled time step during step 50.

In practice, this resolution involves finding an operating setpoint which, when applied to the controlled time step of all the predictive operating scenarios obtained by virtue of the determination method 30′ described hereafter, allows the following objectives to be achieved:
for each of the predictive scenarios, maximising the predictive charging percentage of each electric vehicle Vi at the end of its charging session;
for each of the predictive scenarios, permanently maintaining the total amount of electrical energy delivered by the power supply system P to the plurality of charging stations S1-Sn below the predetermined maximum energy threshold; and
for each of the predictive scenarios, minimising the cost of the electrical energy delivered by the power supply system P to the plurality of charging stations S1-Sn.

In other words, this resolution involves finding the operating setpoint that maximises the achievement of the three objectives sought by the two-stage stochastic programming model when it is applied to the controlled time step of each of the predictive operating scenarios.

Thus, the operating setpoint determined by resolving the equation expressed above does not correspond to a setpoint that would be perfect for implementing a single predictive operating scenario selected from among all the predictive operating scenarios, but to a setpoint that optimises the achievement of the objectives, on average, over each of the predictive operating scenarios.

The method for determining a predictive scenario implemented several times during step 30, i.e., the determination method 30′, will now be described with reference to FIG. 2. Each time the determination method 30′ is implemented, a sample k of the collection K is obtained. The determination method 30′ is preferably implemented by the computation device C.

The determination method 30′ allows a digital representation of a predictive operating scenario of the charging station system I to be determined comprising, for each time step of the predetermined time interval, the state of each charging station Si. This digital representation is, for example, a computer file stored in a memory of the computation device C and can be used by the computation device to implement the control method 10.

The determination method 30′ is implemented cyclically, for each time step of the predetermined time interval.

To summarise, the determination method 30′ comprises, for each charging station Si and for each time step of the predetermined time interval, maintaining the charging station Si in its state or changing the state of the charging station, with a probability of changing the state of the charging station, i.e., of switching the state of the charging station, being computed based on:
the time and date corresponding to the active time step;
a session duration, expressed as a number of time steps, separating the active time step from the last past time step during which the charging station Si changed state; and
if the charging station is in the active state, a remaining duration, expressed as a number of time steps, separating the active time step from a future time step corresponding to a time and a date for the end of charging of the electric vehicle Vi, with the time and the date for the end of charging of the electric vehicle being determined during a past time step during which the charging station Si switched to the active state.

More specifically, the determination method 30′ starts during a step 31, which corresponds to the execution of the determination method 30′ for the initial time step of the predetermined time interval.

The determination method 30′ then comprises a step 32, during which, for each charging station Si, the state of the charging station Si is determined, i.e., the step involves determining whether the charging station Si is in an active or inactive state.

Step 32 is implemented after step 31, when the active time step corresponds to the initial time step of the predetermined time interval, or even after step 38 described hereafter, when the active time step is different from the initial time step.

In practice, for the initial time step of the predetermined time interval, the state of each charging station Si is determined by obtaining the state of the charging station based on input data, which is provided before implementing the method. In other words, for the initial time step, the state of each charging station determined during step 32 corresponds to the actual state of each charging station.

Furthermore, for time steps other than the initial time step, the state of each charging station Si is determined by obtaining the state of the charging station at the end of the previous time step, for example, at the instant separating the initial time step from the controlled time step, i.e., during step 38 of the previous cycle of the determination method 30′.

If the charging station Si is in the active state, the determination method 30′ continues with steps 33 to 36 described hereafter.

If the charging station Si is in an inactive state, the determination method 30′ continues with a step 37 described hereafter.

The determination method 30′ therefore comprises a step 33 implemented after step 32 for charging stations Si in the active state, during which the duration separating the active time step from the future time step corresponding to the announced end of charging time and date of the electric vehicle, i.e., the announced end of charging time, is measured. This duration is referred to as the “remaining duration” throughout the remainder of the description. In practice, the remaining duration is expressed as a number of time steps separating the active time step from the future time step including the announced end of charging time.

It is understood that this duration cannot be established for charging stations Si in the active state for which the electric vehicle Vi has not communicated an announced end of charging time when it is connected to the charging station.

If the remaining duration measured during step 33 is equal to zero time steps, i.e., if the active time step corresponds to the time step including the announced end of charging time, then the determination method 30′ continues with a step 34, during which the charging station Si switches to the inactive state. Step 34 therefore allows end of charging times announced by the users of the electric vehicles Vi to be taken into account. Following step 34, the determination method 30′ continues with step 37 described hereafter.

The determination method 30′ therefore comprises a step 37 implemented after step 32 for charging stations Si in an inactive state, or implemented after step 34 for charging stations Si detected in an active state during step 32 and having switched to an inactive state during step 34.

During step 37, the determination method 30′ maintains the charging station Si in the inactive state, or even switches the charging station to the active state, with a probability of switching the charging station to the active state that ranges between 0 and 1.

In practice, the probability of switching the charging station to the active state is equal to a first value. The method for obtaining the first value is described hereafter.

Furthermore, during step 37, when the charging station Si is switched to the active state, then an initial charging request kⁱ, expressed as an amount of electrical energy, is computed and associated with the charging station. This initial charging request kⁱ is computed using a regressor model. The method for computing the initial charging request using a regressor model is described hereafter.

In the example, during step 37, when the charging station Si is switched to the active state, then no end of charging time associated with the charging station Si is estimated. As a variant of the invention, during step 37, when the charging station Si is switched to the active state, an end of charging time associated with the charging station Si is estimated.

Following step 37, the determination method 30′ continues with a step 38, described hereafter.

If the remaining duration measured during step 33 is greater than zero time steps, or even if the charging station Si is in the active state without an associated announced end of charging time, then the determination method 30′ continues with a step 35.

During step 35, the determination method 30′ maintains the charging station Si in the active state, or even switches the charging station to the inactive state with a probability of switching the charging station to the inactive state that ranges between 0 and 1.

In practice, the probability of switching the charging station Si to the inactive state is equal to a second value when an end of charging time is associated with the charging station, or is even equal to a third value when no end of charging time is associated with the charging station. The methods for obtaining the second and third values are described hereafter.

It is then understood that, in the example, for any charging station Si that has switched to the active state during a step 37 of a previous cycle of the determination method 30′, then the probability of switching the charging station Si to the inactive state is equal to the third value, since no end of charging time associated with a charging station Si is estimated during step 37. Thus, the probability of switching the charging station Si to the inactive state is equal to the second value only for charging stations Si that have been in the active state since the start of the determination method 30′, i.e., since step 31, or even since the start of the initial time step of the predetermined time interval. In other words, the probability of switching the charging station Si to the inactive state is equal to the second value only for charging stations Si that have actually switched to the active state prior to the implementation of the determination method 30′, when an electric vehicle Vi has actually been connected to these charging stations and an end of charging time has actually been announced.

After step 35, the determination method 30′ comprises a step 36, during which the state of the charging station Si is determined, i.e., the step involves determining whether the charging station Si is in an active or inactive state. It is understood that, during step 35, the charging station is in an active state if it has not switched state during step 33, and that it is in an inactive state if it has switched state during step 33.

If, during step 36, the charging station Si is in an inactive state, the determination method 30′ continues with step 37, as described above, then with step 38, as described hereafter. It is then understood that, during the same time step, a charging station Si that is initially in the active state can successively switch to the inactive state, during step 35, and then switch to the active state, during step 37.

If, during step 36, the charging station Si is in the active state, the determination method 30′ continues with step 38.

Step 38 corresponds to the end of a cycle of the determination method 30′. In other words, at the start of step 38, steps 32 to 37 have been implemented for each charging station Si of the charging station system I. Thus, one cycle of the determination method 30′ corresponds to one implementation of steps 32 to 38.

Step 38 involves determining whether the active time step corresponds to the last time step of the predetermined time interval.

If the active time step is different from the last time step of the predetermined time interval, then the determination method 30′ transitions to the next time step, i.e., the active time step is incremented, and steps 32 to 37 are implemented again, as described above.

If the active time step corresponds to the last time step of the predetermined time interval, then the determination method 30′ ends with a step 39.

During step 39, the determination method 30′ determines the digital representation of the predictive operating scenario of the charging station system I comprising, for each time step of the predetermined time interval, the state of each charging station Si at the end of the time step, i.e., during step 38. Preferably, this digital representation also comprises, for each time step and when a charging station Si is in the active state, the initial charging request ki associated with the charging station. This predictive operating scenario of the charging station system I thus corresponds to a sample k of the collection K used by the two-stage stochastic programming model implemented during step 40 of the control method 10.

The methods for computing the first, second and third values and the initial charging request will now be described.

The first value, which corresponds to the probability of switching a charging station Si from its inactive state to its active state during step 37, is computed based on:
the time and date corresponding to the active time step; and
a session duration, expressed as a number of time steps, separating the active time step from the past time step during which the charging station Si switched to the inactive state.

In practice, if the past time step during which the charging station Si switched to the inactive state does not form part of the predetermined time interval, i.e., if it is prior to the initial time step, then the number of time steps separating this past time step from the initial time step is supplied to the determination method 30′ as input data.

Based on this information, the first value is preferably obtained using a gradient-boosting classifier machine learning algorithm, for example, using version 1.2 of the CatBoost library.

Advantageously, this machine learning algorithm is trained based on the operating log of the charging station system I. Thus, the first value reflects the probability that, at a given time and date, a charging station will switch to the active state, taking into account the duration during which the charging station has remained in the inactive state. For example, a charging station has a higher probability of switching to the active state at the end of a working day, for example, at 6 p.m., than on a Sunday in the middle of the night, for example, at 4 a.m.

The second value, which corresponds to the probability of switching a charging station Si from its active state to its inactive state when an end of charging time is associated with the charging station, during step 35, is computed based on:
the time and date corresponding to the active time step;
a session duration, expressed as a number of time steps, separating the active time step from the past time step during which the charging station Si switched to the active state; and
a remaining duration, expressed as a number of time steps, separating the active time step from the future time step including the announced end of charging time.

In practice, the number of time steps separating the past time step, during which the charging station Si switched to the active state, from the initial time step is supplied to the determination method 30′ as input data, in so far as this past time step is prior to the initial time step, since an announced end of charging time is only associated with a charging station when this charging station was in the active state before the determination method 30′ was started.

Based on this information, the second value is preferably obtained using a gradient-boosting classifier machine learning algorithm, using version 1.2 of the CatBoost library, for example.

Advantageously, this machine learning algorithm is trained based on the operating log of the charging station system, in a similar way to that used for the first value.

The fact that the second value is notably obtained by taking into account the remaining duration separating the active time step from the future time step, including the announced end of charging time associated with training based on the operating log of the charging station system I, is particularly advantageous, as this allows, when computing the probability of each charging station switching to the inactive state, the possible early disconnection of the electric vehicle during charging to be taken into account, i.e., possible non-compliance of the announced end of charging time by the vehicle user. In other words, the second value also reflects the probability that a charging station Si will switch to the inactive state, taking into account the risk of the user of the electric vehicle associated with this charging station not complying with the announced end of charging time. For example, the closer the announced end of charging time is to the active time step, the higher the probability of early disconnection, which is therefore taken into account in the computation of the second value.

The third value, which corresponds to the probability of a charging station Si switching from its active state to its inactive state when no end of charging time is associated with the charging station, during step 35, is computed based on:
the time and date corresponding to the active time step; and
a session duration, expressed as a number of time steps, separating the active time step from the past time step during which the charging station Si switched to the active state.

In practice, if the past time step during which the charging station Si switched to the active state does not form part of the predetermined time interval, i.e., if it is prior to the initial time step, then the number of time steps separating this past time step from the initial time step is supplied to the determination method 30′ as input data.

Based on this information, the third value is preferably obtained using a gradient-boosting classifier machine learning algorithm, using version 1.2 of the CatBoost library, for example.

Advantageously, this machine learning algorithm is trained based on the operating log of the charging station system I, in a similar way to that used for the first value.

The initial charging request ki obtained during step 37 is computed by the regressor model based on:
the time and date corresponding to the active time step; and
a session duration, expressed as a number of time steps, separating the active time step from the past time step during which the charging station Si switched to the inactive state. The session duration thus corresponds to the duration the charging station Si spends in the inactive state before it switches to the active state, since the initial charging request is computed when the charging station switches to the active state.

In practice, if the past time step during which the charging station Si switched to the inactive state does not form part of the predetermined time interval, i.e., if it is prior to the initial time step, then the number of time steps separating this past time step from the initial time step is supplied to the determination method 30′ as input data.

Preferably, the regressor model is implemented using a machine learning algorithm, using, for example, the CatBoostRegressor regressor model available in version 1.2 of the CatBoost library.

In practice, the regressor model is a machine learning model for predicting a quantitative variable as a function of other variables. Thus, in the example, the regressor model predicts the initial charging request based on the time and date corresponding to the active time step and the session duration separating the active time step from the past time step during which the charging station Si switched to the inactive state. Thus, the regressor model is notably trained based on the operating log of the charging station system I.

Advantageously, this machine learning algorithm is trained based on the operating log of the charging station system I, in a similar way to that used for the first value.

By virtue of the determination method 30′, the collection K of samples used to implement the two-stage stochastic programming model of the control method 10 is qualitative, as it incorporates the risk of early disconnection of electric vehicles by their users. Thus, the control method 10 is more reliable and results in more realistic predictions: the issued operating setpoint is thus more effective in achieving good user satisfaction, while minimising the cost of the electricity consumed by the charging station system and without exceeding the predetermined maximum energy threshold. In particular, in order to minimise this cost, the control method 10 tends to smoothen the charging of the electric vehicles Vi over time, in order to avoid the occurrence of charging spikes, during which the charging station system consumes a significant amount of electrical power. Taking into account early disconnections allows this smoothing to be achieved while minimising the risk of delaying the charging of an electric vehicle to such an extent that the occurrence of an early disconnection would result in the disconnection of an electric vehicle that had reached a low percentage of its initial charging request, or had not been charged at all.

Compared with known methods for controlling charging station systems, the control method 10 of the invention thus allows user satisfaction to be significantly increased without a significant increase in the cost of the electricity consumed by the charging station system.

Advantageously, the determination method 30′ also can be used for applications other than the control method 10. For example, the predictive operating scenarios obtained using the determination method 30′ can be used to assist with the dimensioning of a charging station system during the design phase, notably by assisting the selection of a maximum amount of electrical power for the power supply system, in order to take into account charging spikes that are simulated by virtue of the predictive operating scenarios.

In the example, the duration separating two executions of the control method 10 is equal to the duration of a time step of the predetermined time interval during which the determination method 30′ is implemented. As a variant of the invention, the duration separating two executions of the control method 10 is different from the duration of a time step of the predetermined time interval, for example, equal to an integer multiple of the duration of a time step of the predetermined time interval. In such a variant, the periodicity of the control method 10 is then different from the periodicity of the determination method 30′.

As a variant of the invention, the determination method 30′ is not implemented periodically. For example, the duration separating two executions of the control method 10 varies according to the time of day, being longer at night and shorter during the day, and/or according to the occupancy rate of the charging station system I, with the duration separating two executions of the control method 10 decreasing when a large number of electric vehicles is connected to the charging station system. According to another example, the determination method 30′ is executed as soon as an event occurs on the charging station system I, such as the connection or disconnection of an electric vehicle to/from a charging station Si. According to another example, the duration separating two executions of the control method 10 is selected so as to correspond to the frequency of any changes to the price of electricity, in the case whereby the price of electricity varies over the course of a day. In other words, the control method 10 is synchronised with changes in the price of electricity.

In the example, steps 20, 30 and 40 of the control method 10 are shown as being executed during the initial time step, or at the end of the initial time step, and step 50 is shown as being executed during the controlled time step. Another way of describing the invention involves not considering an initial time step and a controlled time step, but considering that steps 20, 30 and 40 of the control method 10 are executed at an initial instant of the control method 10, then that step 50 is executed during a time period, which starts at the initial instant. In other words, steps 20, 30 and 40 are implemented when the execution of the control method 10 starts, and then the operating setpoint that is obtained is then applied during this time period. In practice, the duration of this time period can be equal to, or different from, the duration of a time step of the predetermined time interval used to execute the determination method 30′ and the duration of this time period corresponds to the duration between two executions of the control method 10. In other words, the computation steps of the control method 10 are executed, then the operating setpoint corresponding to the time period is applied, i.e., until the next implementation of the method, then the method is restarted either periodically or irregularly, for example, on demand, following connection to or disconnection from a vehicle. This alternative description of the invention does not change how steps 20 to 50 of the control method 10 are executed.

As a variant, at the end of step 34, during which a charging station SI with a remaining duration equal to zero time steps switched to the inactive state, the determination method 30′ continues with step 38. In other words, in such a variant, a charging station cannot successively switch to the inactive state during step 34 and then switch to the active state during step 37, during the same time step.

As a variant, the determination method 30′ does not comprise steps 33 and 34, or even does not comprise steps 33 and 34 for each cycle. For example, these steps are not implemented when none of the charging stations Si is associated with an announced end of charging time. In such a variant, at the end of step 32 and for each charging station Si in the active state, the determination method 30′ continues with step 35.

As a variant, during the determination method 30′, when the announced end of charging time of an electric vehicle Vi associated with a charging station Si is reached, the charging of the electric vehicle Vi is not terminated if the battery of the electric vehicle is not charged to 100%. In such a variant, the determination method 30′ does not comprise steps 33 and 34, or else step 34 is only implemented when, in addition to the fact that the end of charging time has been reached, the battery of the considered electric vehicle is fully charged. Such a variant allows user satisfaction to be improved, since delayed disconnection of an electric vehicle, i.e., after the end of charging time, then allows the charging of the battery of the electric vehicle to be increased.

As a variant, the determination method 30′ does not comprise step 36 and, at the end of step 35, the determination method continues with step 38. In other words, in such a variant, a charging station cannot successively switch to the inactive state during step 35 and then switch to the active state during step 37, during the same time step.

As a variant, the determination method 30′ and the control method 10 incorporate an analysis of the specific features of the users of the electric vehicles Vi. To this end, an identifier is assigned to each user, with this identifier forming part of the first state variable xₜ^{k}. Thus, it is possible to take into account the fact that a user systematically disconnects their electric vehicle Vi from the associated charging station Si in accordance with the announced end of charging time, or, otherwise, frequently disconnects early. This behaviour is then taken into account when establishing the samples k of the collection K with the determination method 30′, and notably when computing the second value. The operating setpoint established in step 40 of the control method 10 is thus more reliable and more precise, improving user satisfaction.

In the example, the stochastic programming model attempts to maintain the total amount of electrical energy delivered by the power supply system P to the plurality of charging stations S1-Sn below the predetermined maximum energy threshold c̅1̅, and also attempts to minimise the cost of the electrical energy delivered by the power supply system P to the plurality of charging stations S1-Sn, taking into account a predetermined tariff increase threshold c̅2̅, with the thresholds c̅1̅ and c̅2̅being distinct, with the threshold c̅2̅ being lower than the threshold c̅1̅.

As a variant, the stochastic programming model attempts to maintain the total amount of electrical energy delivered by the power supply system P to the plurality of charging stations S1-Sn below the predetermined maximum energy threshold c̅1̅, without attempting to minimise the cost of the electrical energy delivered by the power supply system P to the plurality of charging stations S1-Sn. The only other aim of the stochastic programming model then involves maximising the satisfaction of the users of the electric vehicles Vi charged by the charging station system I.

As a variant, the total cost of the electrical energy delivered by the power supply system P to the plurality of charging stations S1-Sn during a given time step is not obtained by the equation described above for obtaining the total cost variable L, but by another computation mode. For example, this computation incorporates a variable electricity price, notably depending on the electrical power consumed by the charging station system I. According to another example, the penalty ξ paid if the threshold c̅2̅ is exceeded does not correspond to a fixed amount, but to an amount proportional to the amount of electrical energy exceeding the threshold c̅2̅ or to the amount of electrical energy consumed by the charging station system I.

As a variant of the invention, the control method 10 and the determination method 30′ are implemented by two separate computation devices. For example, the control method 10 is implemented by the computation device C, while the determination method 30′ is implemented by a computation device separate from the charging station system I.

Any feature described for one embodiment or variant throughout the above description can be implemented for the other embodiments and variants described above, in so far as technically feasible.

1. A method for determining a predictive operating scenario of a charging station system for electric vehicles over a predetermined time interval comprising a plurality of time steps, the charging station system comprising:
a power supply system; and
a plurality of charging stations, each charging station being configured to be supplied with electrical energy by the power supply system and to deliver electrical energy to an electric vehicle, each charging station being either in an inactive state, when it is incapable of charging an electric vehicle, or in an active state, when it is capable of charging an electric vehicle;
the method comprising, for each charging station and for each time step of the predetermined time interval, maintaining the charging station in its state or changing the state of the charging station, with a probability of changing the state of the charging station being computed based on:
the time and date corresponding to the active time step;
a session duration, expressed as a number of time steps, separating the active time step from the last past time step during which the charging station changed state; and
if the charging station is in the active state, a remaining duration, expressed as a number of time steps, separating the active time step from a future time step corresponding to a time and a date for the end of charging of the electric vehicle, the time and the date for the end of charging of the electric vehicle being determined during a past time step during which the charging station switched to the active state;
the method further comprising a step of determining a digital representation of a predictive operating scenario of the charging station system comprising, for each time step, the state of each charging station.

2. The method according to claim 1, comprising, for each charging station and for each time step of the predetermined time interval, the following steps:
a) determining the state of the charging station;
b) if the charging station is in the inactive state at the start of the time step, then:
maintaining the charging station in the inactive state; or
switching the charging station to the active state and computing an initial charging request, expressed as an amount of electrical energy, with a probability of switching the charging station to the active state that is equal to a first value, the first value is computed based on:
the time and date corresponding to the active time step; and
a session duration, expressed as a number of time steps, separating the active time step from the past time step during which the charging station switched to the inactive state;
c) if the charging station is in the active state at the start of the time step, then:
maintaining the charging station in the active state; or
switching the charging station to the inactive state, with a probability of switching the charging station to the inactive state that is equal to a second value, the second value is computed based on:
the time and date corresponding to the active time step;
a session duration, expressed as a number of time steps, separating the active time step from the past time step during which the charging station switched to the active state; and
a remaining duration, expressed as a number of time steps, separating the active time step from a future time step corresponding to a time and a date for the end of charging of the electric vehicle, the time and the date for the end of charging of the electric vehicle being determined during a past time step during which the charging station switched to the active state;
the digital representation of the predictive scenario further comprising, for each time step and when a charging station is in the active state, the initial charging request associated with the charging station.

3. The method according to claim 2, wherein, during step c):
if the charging station has been in the active state since the start of the initial time step of the predetermined time interval, then the probability of switching the charging station to the inactive state is equal to the second value; and
if the charging station has not been in the active state since the start of the initial time step of the predetermined time interval, then the probability of switching the charging station to the inactive state is equal to a third value, the third value being computed based on:
the time and date corresponding to the active time step; and
a session duration, expressed as a number of time steps, separating the active time step from the past time step during which the charging station switched to the active state.

4. The method according to claim 2, wherein step c) further comprises, after switching the charging station to the inactive state:
switching the charging station to the active state and computing an initial charging request, expressed as an amount of electrical energy, with a probability of switching the charging station to the active state that is equal to the first value.

5. The method according to claim 2, wherein determining the state of the charging station during step a) comprises:
for the first time step of the predetermined time interval, obtaining the state of the charging station from data supplied prior to the implementation of the method; and
for each time step of the predetermined time interval different from the first time step, obtaining the state of the charging station at the end of the preceding time step.

6. The method according to claim 2, wherein, during step b), computing the initial charging request is carried out based on:
the time and date corresponding to the active time step; and
a session duration, expressed as a number of time steps, separating the active time step from the past time step during which the charging station switched to the inactive state.

7. The method according to claim 2, wherein step c) comprises:
checking whether the remaining duration separating the active time step from the future time step corresponding to an announced time and date for the end of charging of the electric vehicle is equal to zero time steps;
if the remaining duration is equal to zero time steps, switching the charging station to the inactive state; and
if the remaining duration is greater than zero time steps, maintaining the charging station in the active state or switching the charging station to the inactive state, with a probability of switching the charging station to the inactive state that is equal to the second value.

8. The method according to claim 2, wherein the first value, the second value and, if applicable, the third value, are respectively obtained using a gradient-boosting classifier machine learning algorithm.

9. A method for controlling a charging station system for electric vehicles, the charging station system comprising:
a power supply system;
a plurality of charging stations, each charging station of the plurality of charging stations being supplied with electrical energy by the power supply system and being configured to deliver electrical energy to an electric vehicle, each charging station being either in an inactive state, when it is incapable of charging an electric vehicle, or in an active state, when it is capable of charging an electric vehicl; and
a computation device, configured to control the amount of electrical energy delivered to each charging station by the power supply system;
the method being implemented by the computation device and comprising the following steps:
a) determining the time and date of the current instant;
b) determining, for each charging station of the plurality of charging stations, whether the charging station is in the inactive state or in the active state at the current instant, and determining an initial charging request associated with each charging station in the active state;
c) generating a plurality of predictive operating scenarios for the charging station system by repeatedly implementing the method for determining a predictive scenario according to claim 1;
d) establishing an operating setpoint of the charging station system, based on:
the state of each charging station determined in step b);
the initial charging request associated with each charging station in the active state determined in step b); and
the plurality of predictive operating scenarios for the charging station system generated in step c);
with the established operating setpoint of the charging station system allocating an amount of electrical energy to be delivered by the power supply system to each charging station; and
e) controlling, by the computation device, the power supply system to deliver the amount of electrical energy allocated to each charging station by the operating setpoint.

10. The method according to claim 9, wherein, during step d), the operating setpoint of the charging station system is established using a two-stage stochastic programming model, in which the operating setpoint of the charging station system represents a decision variable and in which the plurality of predictive operating scenarios for the charging station system, generated by repeatedly implementing the method for determining a predictive scenario during step c), represents a probability distribution.

11. The method according to claim 10, wherein the two-stage stochastic programming model attempts to:
maintain a total amount of electrical energy delivered by the power supply system to the plurality of charging stations below a predetermined maximum energy threshold; and
maximise a charging percentage of each electric vehicle charged by a charging station in the active state, the charging percentage xₜⁱ of each electric vehicle being obtained using the following equation:
$${x}^{i} = 1 - \frac{{r}^{i}}{{k}^{i}}$$
where:
kⁱ corresponds to the initial charging request associated with the charging station;
rⁱ corresponds to the remaining amount of electrical energy to be delivered to the electric vehicle associated with the charging station in order to fulfil the initial charging request.

12. The method according to claim 9, wherein, during step d), the operating setpoint of the charging station system is also established based on the deviation between an operating setpoint determined by a previous execution of the control method and the amount of electrical energy actually delivered to each charging station since said previous execution of the control method.

13. The method according to claim 9, wherein steps a) to e) are implemented periodically, being repeated after a duration that is equal to the duration of a time step of the predetermined time interval.

14. A charging station system for electric vehicles comprising:
a power supply system;
a plurality of charging stations, each charging station of the plurality of charging stations being supplied with electrical energy by the power supply system and being configured to deliver electrical energy to an electric vehicle; and
a computation device, configured to control the amount of electrical energy delivered to each charging station by the power supply syste;
wherein the computation device is configured to implement the control method of any one of claim 9.
